(19) United States
(12) Patent Application Publication
(10) Pub. No.: US 2024/0165570 A1
(43) Pub. Date: May 23, 2024

(54) MIXING SYSTEM AND A METHOD FOR MIXING A PRIMARY FLUID WITH A FLOWABLE SECONDARY SUBSTANCE

(71) Applicant: Levitronix GmbH, Zurich (CH)

(72) Inventors: Rennan HU, Zürich (CH); Samuel SCHNEIDER, Opfikon (CH); Jürgen HAHN, South Grafton, MA (US); Natale BARLETTA, Zürich (CH)

(21) Appl. No.: 18/382,867

(22) Filed: Oct. 23, 2023

(30) Foreign Application Priority Data
Nov. 21, 2022 (EP) 22208655.5

(51) Int. Cl. B01F 25/312; B01F 23/50; B01F 25/51; B01F 35/21; B01F 35/212; B01F 35/221; B01F 35/60; B01F 35/71; F04D 1/00

(52) U.S. Cl. CPC B01F 25/31243; B01F 23/56; B01F 25/51; B01F 35/2113; B01F 35/212; B01F 35/2211; B01F 35/602; B01F 35/7176; F04D 1/00

(57) ABSTRACT

A mixing system includes an eductor, a supply connection connected to a reservoir for a primary fluid, a discharge connection, a storage container for a secondary substance, a centrifugal pump to convey the primary fluid through the supply connection, and a controller to control the centrifugal pump. The eductor includes a primary inlet for the primary fluid, a secondary inlet for the secondary substance, an outlet for a mixed fluid, and a suction chamber to suck the secondary substance, the primary inlet connected to the supply connection so that the primary fluid can flow from the reservoir into the eductor and the outlet connected to the discharge connection so that the mixed fluid can be discharged from the eductor. The secondary inlet is at the suction chamber and connected to the storage container. A closing device is between the suction chamber and the storage container.

### CROSS-REFERENCE TO RELATED APPLICATION

This application claims priority to European Application No. 22208655.5, filed Nov. 21, 2022, the contents of which are hereby incorporated by reference.

### BACKGROUND

### Technical Field

The disclosure relates to a mixing system having an eductor and to a method for mixing a primary fluid with a flowable secondary substance. The disclosure further relates to a set of single-use parts for such a mixing system.

### Background Information

Conventional mixing systems which comprise an eductor can be used, for example, in the pharmaceutical industry, in biotechnology or in medical technology. An eductor is a device which is used for mixing a flowable secondary substance, for example a powder, into a primary fluid, for example a liquid such as water. The primary fluid is highly accelerated by a convergingly designed inlet nozzle of the eductor and introduced into a suction chamber. Based on Bernoulli's equation, a negative pressure is created in the suction chamber, by which the secondary substance is sucked into the flow of the primary fluid. For this purpose, the suction chamber has a secondary inlet through which the secondary substance is sucked in and introduced into the flow of the primary fluid. Downstream of the suction chamber, an outlet nozzle is provided in which the primary fluid and the secondary substance mix with each other. The outlet nozzle is often designed as a Venturi nozzle.

According to a common design, the secondary substance is stored in a storage container, which is designed, for example, as a hopper. This container is placed on or connected to the secondary inlet of the eductor so that the secondary substance can be sucked from the storage container into the suction chamber.

Thus, the eductor fulfills two tasks, namely the addition of the secondary substance to the primary fluid and the mixing of the secondary substance with the primary fluid.

The flowing primary fluid is often referred to as motive flow, while the flowing secondary substance is referred to as suction flow.

### SUMMARY

A mixing system with an eductor normally comprises, in addition to the eductor, a reservoir for the primary fluid, such as a tank, a supply connection which connects the reservoir to a primary inlet of the eductor, a discharge connection through which the primary fluid intermixed with the secondary substance is discharged as mixed fluid, the storage container for the secondary substance, designed, for example, as a hopper, which is connected to the secondary inlet of the eductor, and a pump, usually a centrifugal pump, arranged in the supply connection, with which the primary fluid is conveyed from the reservoir through the supply connection and through the eductor. Due to the strong acceleration in the inlet nozzle of the eductor, the secondary substance is then sucked into the suction chamber and meets the flow of the primary fluid there. In the outlet nozzle, the primary fluid and the secondary substance mix with each other. The mixture of the primary fluid and the secondary substance exits as mixed fluid through the outlet nozzle and can then be recirculated to the reservoir for the primary fluid via the discharge connection in order to achieve a continuous increase in the concentration of the secondary substance in this way, or the mixture of the primary fluid and the secondary substance is discharged from the process. Mixing systems with eductors are used both in discontinuous production processes, such as batch processes, and in continuous production processes.

Depending on the respective process, the mixed fluid, i.e., the primary fluid mixed with the secondary substance, is recirculated through the discharge connection to the reservoir or is made available for removal at a system outlet. Of course, it is also possible to discharge only a part of the mixed fluid from the process and recirculate the remainder into the reservoir.

In the operating state, the primary fluid is conveyed by the pump through the inlet nozzle, which opens into the suction chamber. In this process, the primary fluid is strongly accelerated in the inlet nozzle by its converging design, which creates the negative pressure in the suction chamber that sucks the secondary substance from the storage container through the secondary inlet into the suction chamber. The suction power of the eductor is a measure of what amount or mass, or volume of secondary substance is sucked into the suction chamber per time. The suction power depends on the negative pressure generated in the suction chamber and is usually adjusted via an operating parameter of the centrifugal pump. Typically, this operating parameter is the rotational speed of the pump. The rotational speed of the pump determines the flow rate of the primary fluid through the supply connection, and thus the flow velocity of the fluid. The negative pressure generated in the suction chamber and thus the suction power of the eductor depends on the flow velocity of the primary fluid.

As already stated, the eductor is usually assembled from the three components inlet nozzle, suction chamber, and outlet nozzle. These separate components can be connected to each other by different methods, such as bonding, welding or screwing. The components are made, for example, from plastics such as polyvinyl chloride (PVC), perfluoroalkoxy polymers (PFA), polypropylene (PP), or poly vinylidene fluoride (PVDF) available under the trade name Kvnar®.

However, it is also possible to manufacture the eductor, i.e., in particular the three components inlet nozzle, suction chamber and outlet nozzle, as a one-piece structural unit, i.e., with a monolithic design.

Mixing systems with eductors are also used in particular in the biotechnological and pharmaceutical industries, for example to mix a powder into a liquid, e.g., water or a nutrient liquid. Eductors are also used for mixing liquids as a secondary substance into a primary fluid that is different therefrom. The reservoir for the primary fluid can be, for example, a bioreactor, or a tank in which water or another liquid is stored as the primary fluid. In particular in such cases where the mixed fluid is recirculated into the reservoir through the discharge connection, it is of course also possible to additionally feed fresh primary fluid, i.e, primary fluid that has not yet been mixed with the secondary substance, into the reservoir as required.

In particular, but not only, in the biotechnological and pharmaceutical industries, very high demands are often placed on the purity of processes. Processes often even have to be carried out under sterile conditions Sterilizing the devices used for the process, for example by means of steam sterilization, is very often a time-consuming and cost-intensive factor. For this reason, there is an increasing tendency today to design components of the device as single-use parts for such processes in order to avoid time-consuming cleaning or sterilization processes or to reduce them to a minimum. For this reason, components or devices that come into direct contact with the biological substances or pharmaceutical substances during the process are often designed as single-use parts. The term “single-use parts” refers to parts or components that are used only once in accordance with their intended purpose. After use, the single-use parts are disposed of and replaced for the next application by new, i.e., not yet used, single-use parts.

In particular—but not only—with regard to single-use parts, it is an essential aspect that the single-use parts can be assembled in the simplest possible way with other components of the system, for example those which are designed for multiple use, i.e., which can be reused. The single-use parts should therefore be able to be replaced in a very simple way without the need for a great deal of assembly work.

It has been determined that in mixing systems with eductors, the eductor generates a negative pressure in its suction chamber and thus a suction effect on the secondary substance only when there is a flow of the primary fluid, for example when the centrifugal pump is running. However, there can also be operating states in which the eductor generates no suction power at all or insufficient suction power. In this case, there is too little negative pressure or no negative pressure at all or even excess pressure in the suction chamber.

In particular in applications where the secondary substance is a powder, a suction power that is not optimally adjusted can lead to the fact that the powder does not flow out of the storage container in the desired way. This can lead to powder residues in accumulation zones in the storage container or to ratholing or bridging in the storage container, which has the consequence that no powder at all or only a too small amount of powder is sucked into the suction chamber, whereby the success of the process carried out in the mixing system is at least endangered.

Operating states with too little negative pressure or excess pressure in the suction chamber can have several causes. For example, the centrifugal pump can be operating at an operating point that is not optimal for the process currently running, or the centrifugal pump can fail completely, e.g., due to a power failure or other operational malfunction. If the centrifugal pump fails, the hydrostatic pressure of the mixed fluid located in the discharge connection weighs on the outlet of the eductor. This hydrostatic pressure can lead to an excess pressure in the suction chamber.

Another cause can be an obstruction, for example in the outlet nozzle or at the outlet of the eductor. In particular, if there is excess pressure in the suction chamber, there is a considerable risk of an undesirable leakage flow from the suction chamber through the secondary inlet of the eductor into the storage container for the secondary substance. Such a leakage flow can lead to considerable process disturbances and even to the complete uselessness of the process result.

Starting from this state of the art, it is therefore an object of the disclosure to propose a mixing system with an eductor and a method for mixing a primary fluid with a flowable secondary substance, which enable a higher operational reliability of the mixing process.

The subject matter and embodiments meeting these objects is characterized by the features set forth in the present disclosure.

According to the disclosure, a mixing system with an eductor is thus proposed for mixing a primary fluid with a flowable secondary substance, with a supply connection which can be connected to a reservoir for the primary fluid, with a discharge connection for discharging a mixed fluid, with a storage container for the secondary substance, with a centrifugal pump for conveying the primary fluid through the supply connection, and with a control unit for controlling the centrifugal pump, wherein the eductor comprises a primary inlet for the primary fluid, a secondary inlet for the secondary substance, an outlet for the mixed fluid, and a suction chamber for sucking the secondary substance, wherein the primary inlet is connected to the supply connection so that the primary fluid can flow from the reservoir into the eductor, wherein the outlet is connected to the discharge connection so that the mixed fluid can be discharged from the eductor, wherein the secondary inlet is provided at the suction chamber and is connected to the storage container, wherein a closing device with an open position and a closed position is provided between the suction chamber and the storage container, wherein the secondary substance can flow from the storage container into the suction chamber when the closing device is in the open position, and the closing device prevents a flow of the secondary substance from the storage container into the suction chamber in the closed position. A sensor is provided, with which a suction power of the eductor can be determined, wherein the sensor is signal-connected to the control unit, and wherein the control unit is designed to control the centrifugal pump in dependence of the determined suction power.

The suction power of the eductor can be monitored with the aid of the sensor. In this way, it can be detected immediately if the suction power changes or deviates from the correct value. Thus, it can be detected in particular if there is too little negative pressure or an excess pressure in the suction chamber of the eductor. In the event of the occurrence of such an undesirable operating state, it is therefore possible to react immediately. For example, an operating parameter of the pump, preferably the rotational speed of the pump, can be changed in order to change the conveying capacity of the pump and thus to adjust the suction power of the eductor to a pre-determinable or optimum value. If the pump fails, or if for some other reason there is too much pressure in the suction chamber which cannot be corrected by changing the rotational speed of the pump, it is possible to set the closing device to the closed position so that a leakage flow from the suction chamber into the storage container is reliably prevented. Even if the hydraulic or hydrostatic pressure of the mixed fluid in the discharge connection is present at the outlet of the eductor when the pump is at a standstill, a leakage flow from the suction chamber into the storage container can be reliably prevented. This results in significantly higher operational reliability of the mixing process.

The sensor and the closing device are further advantageous with regard to the beginning of the mixing process when the centrifugal pump is started. Before the centrifugal pump is started, the closing device is in the closed position so that no secondary substance can flow into the suction chamber. Then the centrifugal pump is started and begins to generate a flow through the eductor. The suction power, in this case the negative pressure prevailing in the suction chamber, can be determined with the aid of the sensor. Only when the negative pressure has reached a pre-determinable setpoint, the closing device is set—manually or automatically—from the closed position to the open position, so that the secondary substance is sucked into the suction chamber.

The information determined by the sensor is transmitted to the control unit and evaluated there. If the suction power is sufficiently high, i.e., for example, the negative pressure prevailing in the suction chamber has reached the setpoint, the control unit can cause an acoustic and/or optical signal which indicates to the operator that the closing device can now be set to the open position.

Since the control unit controls the centrifugal pump, it is also possible to change, optimize or adapt the suction power to the current process conditions during the process with the aid of the information supplied by the sensor. In particular, a regulation of the suction power of the eductor can also be realized via the control of the centrifugal pump.

According to a preferred embodiment, the supply connection is connected to the reservoir for the primary fluid, and the discharge connection is connected to the reservoir so that the mixed fluid can be returned from the outlet of the eductor into the reservoir.

In other embodiments, the discharge connection can also be designed to remove the mixed fluid partially or completely from the process.

According to a preferred embodiment, a first shut-off valve is disposed in the discharge connection, which is preferably arranged near the outlet of the eductor. The first shut-off valve serves as a safety valve and can be closed, for example, if the centrifugal pump fails or if there is an obstruction or another blockage on the outlet side of the eductor, for example in the outlet nozzle. By the first shut-off valve, applying the hydrostatic pressure of the fluid in the discharge connection to the outlet of the eductor can be prevented. Hereby, a backflow of the mixed fluid through the outlet into the outlet nozzle of the eductor can also be effectively prevented. If, as is preferred, the discharge connection is realized by a flexible tube or by several flexible tubes, the shut-off valve can be designed in particular as a pinch valve.

Alternatively or in addition to the first shut-off valve, a second shut-off valve can be disposed in the supply connection between the centrifugal pump and the primary inlet of the eductor. The second shut-off valve serves as a safety valve. Particularly in the event of operational malfunctions, the flow connection between the centrifugal pump and the primary inlet of the eductor can be closed with the aid of the second shut-off valve. If, as is preferred, the supply connection is realized by means of a flexible tube or by means of several flexible tubes, the shut-off valve can in particular be designed as a pinch valve.

Preferably, each shut-off valve is designed as a controllable shut-off valve which can be controlled by the control unit. Thus, in the event of a malfunction, the shut-off valves can be closed automatically by the control unit without the need for an intervention by the operating personnel.

For the same reason, it is also preferred that the closing device is designed for a control by the control unit, whereby the control unit is designed for an automatic actuation of the closing device.

Preferably, the control unit is designed in such a way that it closes the supply connection and/or closes the discharge connection, and/or sets the closing device in the closed position if the suction power drops below a threshold value. This threshold value can be predetermined and typically depends on the respective application.

Particularly preferably, the sensor is designed as a pressure sensor. In principle, however, other sensors are also possible to determine the suction power, for example, flow sensors, which are preferably provided in the eductor, at the eductor or in the discharge connection, filling level sensors or level sensors, with which the filling level in the suction chamber can be determined, or sensors for conductivity measurement, with which, for example, the powder proportion or the proportion of the secondary substance in the mixed fluid can be determined via the electrical conductivity.

It is a further preferred measure, to provide an additional reservoir between the secondary inlet of the eductor and the closing device for receiving a fluid flowing back from the discharge connection. This measure is particularly advantageous if no first shut-off valve is provided in the discharge connection or if the closing device can only be operated manually. For example, if the centrifugal pump then fails, the (mixed) fluid flowing back from the discharge connection into the eductor is received in the additional reservoir and does not penetrate into the storage container for the secondary substance, even if the closing device is in the open position. The additional reservoir is preferably designed in terms of its volume in such a way that it can receive the maximum amount of mixed fluid that can flow back into the eductor through the outlet in the event of a failure of the centrifugal pump.

According to a preferred embodiment, the centrifugal pump comprises a pump unit having a pump housing in which a rotor is provided for conveying the primary fluid, and a stator which forms an electromagnetic rotary drive with the rotor, wherein the rotor can be magnetically driven without contact and can be magnetically levitated without contact with respect to the stator, and wherein the pump unit is designed in such a way that the pump unit can be inserted into the stator. This design is particularly—but not only—advantageous if as many components of the mixing system as possible are designed as single-use parts.

In a preferred embodiment of the mixing system according to the disclosure, some components of the mixing system, in particular those components which come into contact with the mixed fluid or with the secondary substance or, depending on the application, with the primary fluid, are designed as single-use parts which, according to the intended use, can be used only once and must be replaced after this use by new, i.e., unused, single-use parts.

Therefore, a set of single-use parts for a mixing system is further proposed by the disclosure, which comprises at least the following components, each designed as a single-use part:
the eductor
optionally the storage container for the secondary substance
the pump unit for the centrifugal pump
the closing device
a plurality of tubes designed for realizing the supply connection and the discharge connection.
and optionally the reservoir for the primary fluid.

Preferably, the set of single-use parts comprises the storage container for the secondary substance. Such embodiments are also possible in which the storage container is an integral part of the eductor. For example, the secondary inlet can be designed in such a way that it is large enough to receive the secondary substance. The storage container is then a part of the secondary inlet.

Depending on the application, the reservoir for the primary fluid can be designed as a single-use part or also for multiple use, for example as a stainless-steel tank. If the reservoir is designed for multiple use, the set of single-use parts preferably also comprises a sterile connector with which the supply connection can be connected to the reservoir.

It is understood that this list of components designed as single-use parts is not exhaustive. The set of single-use parts can also comprise other single-use parts, for example the sensor or components of the sensor.

A method for mixing a primary fluid with a flowable secondary substance is further proposed by the disclosure, comprising the following steps:
a mixing system designed according to the disclosure is provided.
the closing device is set in the closed position,
the primary fluid is conveyed through the eductor by means of the centrifugal pump,
the suction power of the eductor is determined by means of the sensor and the control unit,
the closing device is set in the open position when the suction power is greater than a predeterminable limit value.

The advantages of the method according to the disclosure correspond analogously to those already explained in connection with the mixing system according to the disclosure.

Preferably, the supply connection and/or the discharge connection are closed if the suction power drops below a threshold value. In particular, the supply connection and the discharge connection can thus also be closed. The closing of the supply connection and/or the discharge connection is particularly preferably performed automatically by the control unit.

Furthermore, it is preferred that the closing device is set in the closed position if the suction power drops below a threshold value. This can be carried out manually by operating personnel or automatically by the control unit.

Particularly preferably, the pressure in the suction chamber is determined to determine the suction power.

Further advantageous measures and embodiments of the disclosure are set forth herein.

### BRIEF DESCRIPTION OF THE DRAWINGS

The invention will be explained in more detail hereinafter with reference to embodiments as set forth in the drawings.

FIG. 1 illustrates a schematic representation of a first embodiment of a mixing system according to the disclosure,

FIG. 2 illustrates a sectional representation of a first embodiment of an eductor,

FIG. 3 illustrates a schematic representation of a second embodiment of a mixing system according to the disclosure,

FIG. 4 illustrates a schematic representation of a third embodiment of a mixing system according to the disclosure,

FIG. 5 illustrates a perspective representation of an electromagnetic rotary drive of a centrifugal pump, which is designed as a temple motor.

FIG. 6 illustrates an embodiment of a centrifugal pump with a rotor that can be magnetically levitated without contact, in a section in the axial direction,

FIG. 7 illustrates a sectional representation of a second embodiment of an eductor.

FIGS. 8 and 9 illustrate a sectional representation as shown in FIG. 7, but with different variants for the arrangement of at least one pressure sensor,

FIG. 10 illustrates a sectional representation as shown in FIG. 7, but with a connector for a pressure sensor, and

FIG. 11 illustrates a view of a third embodiment of an eductor with an inline sensor

### DETAILED DESCRIPTION

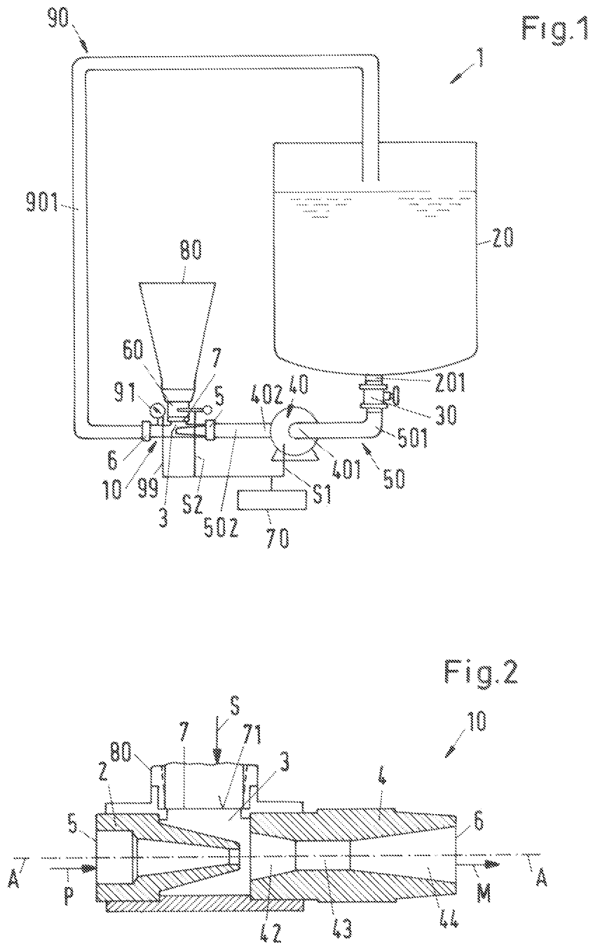

FIG. 1 shows in a schematic representation a first embodiment of a mixing system according to the disclosure, which is designated in its entirety by the reference sign 1. The mixing system 1 comprises an eductor 10 for mixing a primary fluid with a flowable secondary substance. The primary fluid is stored in a reservoir 20, which is designed as a tank, for example. The mixing system 1 further comprises a storage container 80 for the flowable secondary substance to be mixed with the primary fluid. The storage container 80 is designed, for example, as a hopper.

In the following, reference is made to the application example that the mixing system 1 is used for a process in biotechnology or in the pharmaceutical industry. Then, the reservoir 20 can be a bioreactor, for example. The primary fluid is usually a liquid, for example water. The primary fluid can also be a nutrient solution or a cell broth. The flowable secondary substance is preferably a powder or a liquid different from the primary fluid. In the following, reference is made with exemplary character to the fact that the flowable secondary substance is a powder or a material in powder form.

In principle, any eductor known from the state of the art is suitable as an eductor 10. For better understanding. FIG. 2 shows a sectional representation of a first embodiment of the eductor 10. FIG. 2 shows the eductor 10 in a longitudinal section along a center axis A of the eductor 1.

The eductor 10 comprises a convergingly designed inlet nozzle 2 for the primary fluid, a suction chamber 3 for sucking in the flowable secondary substance, and an outlet nozzle 4, which is preferably designed as a venturi nozzle. In the operating state, the primary fluid intermixed with the secondary substance exits through the outlet nozzle 4 as a mixed fluid.

The inlet nozzle 2 has a longitudinal axis by which the center axis A of the eductor 10 is defined. The outlet nozzle 4 has a longitudinal axis lying on the center axis A of the eductor 10, i.e., the inlet nozzle 2 and the outlet nozzle 4 are designed such that their longitudinal axes are aligned with each other.

Viewed in the direction of the center axis A, the suction chamber 3 is arranged between the inlet nozzle 2 and the outlet nozzle 4. The suction chamber 3 has a secondary inlet 7 for the secondary substance. The secondary inlet 7 is connected to the storage container 80 so that the secondary substance can flow from the storage container 80 through the secondary inlet 7 into the suction chamber 3. The flow of secondary substance is also designated as suction flow. The secondary inlet 7 forms an inlet surface 71 through which the secondary substance enters the eductor 10, as the arrow with the reference sign S in FIG. 2 indicates. The secondary inlet 7 is designed in such a way that the normal vector of the inlet surface 71 is perpendicular to the center axis A of the eductor 10.

The convergingly designed inlet nozzle 2 extends from a primary inlet 5 for the primary fluid into the suction chamber 3. In the operating state, the primary fluid flows through the primary inlet 5 in the direction of the center axis A, as the arrow with the reference sign P in FIG. 2 indicates. The flow of the primary fluid is also designated as motive flow.

The outlet nozzle 4 extends from the suction chamber 3 to the outlet 6. In the operating state, the mixed fluid, i.e., the primary fluid mixed with the secondary substance, exits the eductor 10 through the outlet 6, as the arrow with the reference sign M in FIG. 2 indicates

The outlet nozzle 4 is preferably designed as a venturi nozzle. Downstream of the suction chamber 3, the outlet nozzle 4 initially has a converging section 42 as viewed in the flow direction, in which the cross-sectional area of the outlet nozzle 4 available for the flow is reduced to a minimum value. Downstream of the converging section 42, a mixing section 43 can be provided in which the cross-sectional area remains substantially constant. The inner diameter of the outlet nozzle 4 is substantially constant in the mixing section 43. The mixing section 43 serves to mix the primary fluid with the secondary substance. A diverging section 44, which serves as a diffuser and extends to the outlet 6 of the outlet nozzle 4, adjoins the mixing section 43 downstream. In the diverging section 44, the cross-sectional area available for the flow increases as viewed in the flow direction.

Preferably, the eductor 10 is made of a plastic, for example, of one of the following plastics: polyvinyl chloride (PVC), perfluoroalkoxy polymers (PFA), polypropylene (PP), or polyvinylidene fluoride (PVDF) available under the trade name Kynar®.

The mixing system 1 further comprises a supply connection 50 which connects the reservoir 20 to the primary inlet 5 of the eductor 10, so that the primary fluid can flow from the reservoir 20 into the eductor 10. The reservoir 20 comprises an outlet opening 201 which is connected to the supply connection 50. A shut-off element 30 is provided at the outlet opening 201. The flow connection between the reservoir 20 and the supply connection 50 can be opened or closed by means of the shut-off element 30. For example, the shut-off element 30 is designed as a shut-off valve or as an open/close valve. The shut-off element 30 can be designed for manual actuation or also for electrical or another actuation.

A centrifugal pump 40 for conveying the primary fluid is arranged in the supply connection 50, which has a pump inlet 401 and a pump outlet 402 for the primary fluid. Furthermore, a control unit (electronic controller) 70 is provided to control the centrifugal pump 40. Preferably, the control unit 70 comprises a closed loop control with which the operation of the centrifugal pump 40 can be regulated. The control unit 70 is connected to the centrifugal pump 40 via a first control line S1 for controlling the centrifugal pump 40

The mixing system further comprises a discharge connection 90 for discharging the mixed fluid. The discharge connection 90 is connected to the outlet 6 of the eductor 10. In the embodiment described here, the discharge connection 90 is designed as a recirculation line that opens into the reservoir 20. The mixed fluid exiting through the outlet 6 is thus returned through the discharge connection 90 to the reservoir 20, where it mixes with the primary fluid. Such an embodiment of the mixing system 1 is particularly suitable for batch processes. In other embodiments, the mixed fluid is not recirculated into the reservoir, but is removed from the process. In such an embodiment, which is particularly suitable for continuous processes, the discharge connection 90 then extends, for example, from the outlet 6 of the eductor 10 to a removal point or to a tank different from the reservoir 20, in which the mixed fluid is collected. In other embodiments, only a portion of the mixed fluid may be recirculated into the reservoir 20 and another portion can be removed from the process. In these embodiments, the discharge connection usually comprises at least one branch through which a portion of the mixed fluid can be removed while the other portion is recirculated into the reservoir 20.

The supply connection 50 and the discharge connection 90 are preferably realized with conduits that are designed as flexible conduits, i.e., conduits whose walls are deformable. For example, each conduit is designed as a tube, in particular as a plastic tube, made of, for example, a silicone rubber, PVC (polyvinyl chloride), PU (polyurethane), PE (polyethylene), HDPE (high density polyethylene), PP (polypropylene). EVA (ethyl vinyl acetate) or nylon. Preferably, each tube belonging to the supply connection 50 or to the discharge connection 90 is designed for single use. In the design for single use, those components which come into contact with the primary fluid or the secondary substance or the mixed fluid or the substances to be processed, in this case in particular the tubes, are only used exactly once and then replaced by new, i.e., unused, single-use parts during the next application. Depending on the application, the reservoir 20, which comes into contact with the primary fluid, can also be designed for multiple use, for example as a steel tank. If the reservoir 20 is designed for multiple use, e.g., as a steel tank, a sterile connector (not shown) is preferably provided at the outlet opening 201 or at the shut-off element 30 in order to connect the reservoir 20 to the supply connection 50.

The supply connection 50 comprises a supply tube 501 that connects the shut-off element 30 at the reservoir 20 to the pump inlet 401 of the centrifugal pump 40, and a feed tube 502 that connects the pump outlet 402 of the centrifugal pump 40 to the primary inlet 5 of the eductor 10.

The discharge connection 90 comprises a discharge tube 901 that connects the outlet 6 of the eductor to the reservoir 20.

A closing device 60, which has an open position and a closed position, is disposed between the storage container 80 for the secondary substance and the secondary inlet 7 of the eductor 10. When the closing device 60 is in the open position, the secondary substance can flow from the storage container 80 into the suction chamber 3. When the closing device 60 is in the closed position, the flow connection between the storage container 80 and the suction chamber 3 is closed, so that the secondary substance cannot flow from the storage container 80 into the suction chamber 3.

The closing device 60 is designed for manual operation, for example, so that it can be set manually by the operating personnel from the open position to the closed position or from the closed position to the open position.

According to a variant, the closing device is designed for an automatic actuation, for example by the control unit 70, so that the control unit 70 can switch the closing device 60 from the open position to the closed position or from the closed position to the open position. In such embodiments in which the closing device 60 is designed for a control by the control unit 70 and the control unit 70 is designed for an automatic actuation of the closing device 60, a second control line S2 is provided via which the control unit 70 can control the closing device 60. The second control line S2 represented in FIG. 1 is therefore optional and not present if the closing device 60 is designed for a manual actuation.

A sensor 91 is further provided in the mixing system 1, with which a suction power of the eductor 10 can be determined. The sensor 91 is signal-connected to the control unit 70, for example via a signal line 99, so that the sensor 91 can transmit measured values or information to the control unit 70.

In principle, any sensor is suitable as a sensor 91 with which it is possible to determine in the operating state of the mixing system 1 whether a suction power is generated in the suction chamber that enables a proper operation of the eductor 10.

According to a preferred embodiment, the sensor 91 is designed as a pressure sensor 91. The pressure sensor 91 is preferably arranged and designed in such a way that the pressure in the suction chamber 3 can be determined by the pressure sensor 91. The negative pressure prevailing in the suction chamber 3 is then used in particular as a measure of the suction power of the eductor 10.

The pressure sensor 91 is arranged, for example, at or in the outlet nozzle 4 of the eductor 10.

The mixing system 1 for mixing the primary fluid with the flowable secondary substance can be operated, for example, as follows. The mixing system 1 is assembled, the reservoir 20 is filled with the primary fluid and the closing device 60 is in the closed position so that the secondary substance cannot flow out of the storage container 80. The shut-off element 30 is opened so that the flow connection between the reservoir 20 and the supply connection 50 is open

The centrifugal pump 40 is controlled by the control unit 70 and starts to circulate the primary fluid from the reservoir 20 through the eductor 10 and back into the reservoir 20. By means of the sensor 91, the suction power, i.e., for example the pressure or the negative pressure in the suction chamber 3, is determined by the control unit 70. The control unit 70 controls or regulates an operating parameter of the centrifugal pump 40, preferably the rotational speed of the centrifugal pump 40, via the first control line S1 in such a way that the negative pressure prevailing in the suction chamber 3 reaches a predeterminable setpoint. Only when the suction power of the eductor 10 is sufficiently high, for example when the negative pressure in the suction chamber 3 has reached the setpoint, the closing device 60 is set from the closed position to the open position and the mixing process begins

If the closing device 60 is designed for a manual operation, the control unit 70 can cause an optical and/or an acoustic signal and/or a message when the setpoint is reached. Then, the operating personnel can set the closing device 60 from the closed position to the open position so that the secondary substance can be sucked from the storage container 80 into the suction chamber 3. In the suction chamber 3, the secondary substance meets the flow of the primary fluid and is intermixed with the primary fluid in the outlet nozzle 4.

If the closing device 60 is designed for an automatic actuation by the control unit 70, the control unit 70 switches the closing device 60 from the closed position to the open position via the second control line S2, so that the flow connection between the storage container 80 and the suction chamber 3 is opened and the secondary substance is sucked out of the storage container 80 into the suction chamber 3.

Preferably, during operation of the mixing system 1, the suction power of the eductor 10, i.e., for example, the negative pressure in the suction chamber 3, is determined by the sensor 91 and the control unit 70 continuously or at predeterminable time intervals. This makes it possible to monitor whether the negative pressure in the suction chamber 3 still has the desired setpoint. If deviations occur, for example if the negative pressure in the suction chamber 3 is too low or too high, the control unit 70 changes the delivery rate of the centrifugal pump 40 via the first control line S1, for example by increasing or decreasing the rotational speed of the centrifugal pump 40.

If the control unit 70 can no longer control or regulate the centrifugal pump 40 in such a way that the negative pressure in the suction chamber 3 at least approximately reaches the setpoint, or if an undesirable operating state otherwise occurs, e.g., an excess pressure in the suction chamber 3, the closing device 60 is set to the closed position so that the flow connection between the suction chamber 3 and the storage container 80 is closed. In this way, it is possible in particular to avoid a leakage flow, from the suction chamber 3 into the reservoir 80, for example, due to an excess pressure in the suction chamber 3. An undesired inflow of primary fluid or mixed fluid from the suction chamber 3 into the storage container 80 can thus be reliably avoided.

If the closing device 60 is designed for a manual operation, the control unit 70 can cause an optical and/or an acoustic warning signal and/or a warning message if the negative pressure in the suction chamber 3 can no longer be set to the setpoint, or if an undesirable operating state otherwise occurs, e.g., an excess pressure in the suction chamber 3. Then, the operating personnel can manually set the closing device 60 from the open position to the closed position.

If the closing device 60 is designed for an automatic actuation by the control unit 70, the control unit 70 switches the closing device 60 from the open position to the closed position via the second control line S2 in such cases.

In particular, if the closing device 60 is designed for an automatic actuation by the control unit 70, the closing device 60 can be designed as a clamping valve or pinch valve.

An excess pressure in the suction chamber 3 of the eductor 10, which could lead to an undesired flow of the primary fluid or the mixed fluid from the suction chamber 3 into the storage container 80, can occur, for example, if there is a failure of the centrifugal pump 40, e.g., due to a malfunction in the power supply of the centrifugal pump 40. If the centrifugal pump 40 fails, the hydrostatic pressure of the mixed fluid in the discharge connection 90 weighs on the outlet 6 of the eductor 10. This results in an excess pressure in the suction chamber 3, which forces the primary fluid or mixed fluid through the secondary inlet 7 into the storage container 80. This undesired backflow into the storage container 80 can be reliably prevented by setting the closing device 60 to the closed position.

Another possible cause for an excess pressure in the eductor 10 can be an obstruction or a partial blockage or a complete blockage in the eductor 10 downstream of the suction chamber 3, for example in the outlet nozzle 4. In this case, too, a flow of the primary fluid or mixed fluid from the eductor 10 through the secondary inlet 7 into the storage container 80 can be reliably prevented by setting the closing device 60 to the closed position.

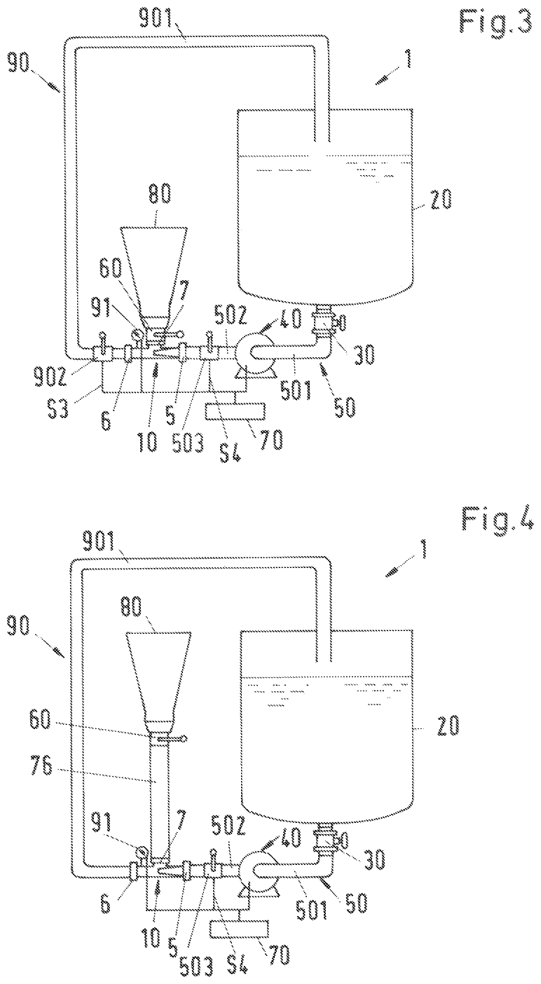

FIG. 3 shows in a schematic representation a second embodiment of a mixing system 1 according to the disclosure. In the following description of the second embodiment, only the differences from the first embodiment will be discussed in more detail. The same parts or parts equivalent in function of the second embodiment are designated with the same reference signs as in the first embodiment. In particular, the reference signs have the same meaning as already explained in connection with the first embodiment. It is understood that all previous explanations of the first embodiment also apply in the same way or in the analogously same way to the second embodiment.

In the second embodiment, a first shut-off valve 902 is provided as a safety valve in the discharge connection 90 of the mixing system 1. The first shut-off valve 902 is arranged downstream of the outlet 6 of the eductor 10 and preferably adjacent to the outlet of the eductor 10. The first shut-off valve 902 can preferably be actuated automatically and is connected to the control unit 70 via a third control line S3, so that the control unit 70 can open or close the first shut-off valve 902. When the first shut-off valve 902 is closed, the flow connection through the discharge connection 90 is closed. Thus, in the event of an undesirable operating state, for example in the event of a failure of the centrifugal pump 40 or in the event of an excess pressure in the suction chamber 3, a backflow of the mixed fluid from the discharge connection 90 through the outlet 6 of the eductor 10 into the suction chamber 3 and from there through the secondary inlet 7 into the storage container 80 can be reliably prevented. In particular, if the discharge connection 90 with the flexible discharge tube 901 is realized, the first shut-off valve 902 can be designed as clamping valve or pinch valve. Preferably, the first shut-off valve 902 is then designed as a controllable magnetic pinch valve. Such a magnetic pinch valve is disclosed, for example, in EP-A-1 132 108.

Of course, it is also possible that the first shut-off valve 902 is designed as a manually operable valve.

As an option, a second shut-off valve 503 is provided as a safety valve in the supply connection 50 of the mixing system 1 as an alternative or supplement to the first shut-off valve 902. The second shut-off valve 503 is arranged between the pump outlet 402 of the centrifugal pump 40 and the primary inlet 5 of the eductor 10. The second shut-off valve 503 is preferably automatically operable and connected to the control unit 70 via a fourth control line S4, so that the control unit 70 can open or close the second shut-off valve 503. When the second shut-off valve 503 is closed, the flow connection through the supply connection 50 between the centrifugal pump 40 and the primary inlet 5 of the eductor 10 is closed. Thus, in the event of an undesirable operating state, for example in the event of a partial or complete blockage in the outlet nozzle 4 of the eductor 10, a flow of the primary fluid from the suction chamber 3 through the secondary inlet 7 into the storage container 80 can be reliably prevented. In particular, if the supply connection 50 is realized with the flexible feed tube 502, the second shut-off valve 503 can be designed as a clamping valve or pinch valve Preferably, the second shut-off valve 503 is then designed as a controllable magnetic pinch valve.

Of course, it is also possible that the second shut-off valve 503 is designed as a manually operable valve.

Particularly preferably, at least one of the shut-off valves 902, 503 or the closing device 60 is designed for an automatic actuation by the control unit 70. Thus, in the event of an undesirable operating state, for example in the event of an excess pressure in the suction chamber 3, the control unit 70 can interrupt the flow connection at least at one point, namely in the supply connection 50, in the discharge connection 9X) or between the suction chamber 3 and the storage container 80, without requiring the intervention of the operating personnel. In particular, if the first shut-off valve 902 and/or the second shut-off valve 503 are designed for an automatic actuation by the control unit 70, it can be advantageous to design the closing device 60 for a manual actuation.

Embodiments are possible in which only the first shut-off valve 902 is provided. Furthermore, embodiments are possible in which only the second shut-off valve 503 is provided, and embodiments are possible in which both the first shut-off valve 902 and the second shut-off valve 503 are provided. If only the second shut-off valve 503 is provided in the supply connection 50, it is preferred that the closing device 60 is designed for an automatic actuation by the control unit 70.

Furthermore, such embodiments are preferred in which each existing shut-off valve 902 and/or 503 is designed as a controllable shut-off valve 902, 503 which can be controlled by the control unit 70.

Preferably, during operation of the mixing system 1, the suction power of the eductor 10 is monitored by means of the sensor 91 and the control unit 70, for example by determining the pressure in the suction chamber 3. If the suction power falls below a predeterminable threshold value, the control unit 70 closes the supply connection 50 by the second shut-off valve 503 and/or the discharge connection 90 by the first shut-off valve 902, and/or the control unit 70 sets the closing device 60 in the closed position.

FIG. 4 shows in a schematic representation a third embodiment of a mixing system 1 according to the disclosure. In the following description of the third embodiment, only the differences from the first and second embodiment will be discussed in more detail. The same parts or parts equivalent in function of the third embodiment are designated with the same reference signs as in the first and the second embodiment. In particular, the reference signs have the same meaning as already explained in connection with the first and the second embodiment. It is understood that all previous explanations of the first and the second embodiment also apply in the same way or in the analogously same way to the second embodiment.

In the third embodiment, only the second shut-off valve 503 is provided in the supply connection 50, but the first shut-off valve 902 is not provided in the discharge connection 90. In the third embodiment, an additional reservoir 76 is disposed between the secondary inlet 7 of the eductor 10 and the closing device 60 for receiving mixed fluid or primary fluid flowing back from the discharge connection 90. The additional reservoir 76 is dimensioned with respect to its volume such that it can receive the entire amount of fluid that flows back into the eductor 10 from the discharge connection 90 through the outlet 6 in the event of a failure of the centrifugal pump 40. The capacity of the additional reservoir 76 is adapted to the respective application, because the maximum amount of fluid that can flow back into the eductor 10 from the discharge connection 90 in the event of a failure of the centrifugal pump 40 depends on the specific design of the discharge connection 90 in the respective application, for example on its length, its diameter and the height difference in the discharge connection 90. In any case, in the respective application, it can be calculated or at least estimated which volume can flow back into the eductor 10 from the discharge connection 90 due to the hydrostatic pressure in the event of a failure of the centrifugal pump 40. The additional reservoir 76 is then dimensioned such that it can receive at least this volume of fluid. Thus, an overflow of the eductor 10 can be avoided, i.e., even if the closing device 60 is not in the closed position, the fluid cannot get out of the suction chamber 3 into the storage container 80 in the event of a failure of the centrifugal pump 40, because it is received by the additional reservoir 76

Of course, it is also possible to provide the additional reservoir 76 in the first embodiment or in the second embodiment of the mixing system 1.

In principle, any type of centrifugal pump with which the primary fluid can be conveyed from the reservoir 20 through the supply connection 50 to the eductor 10 is suitable as the first centrifugal pump 40.

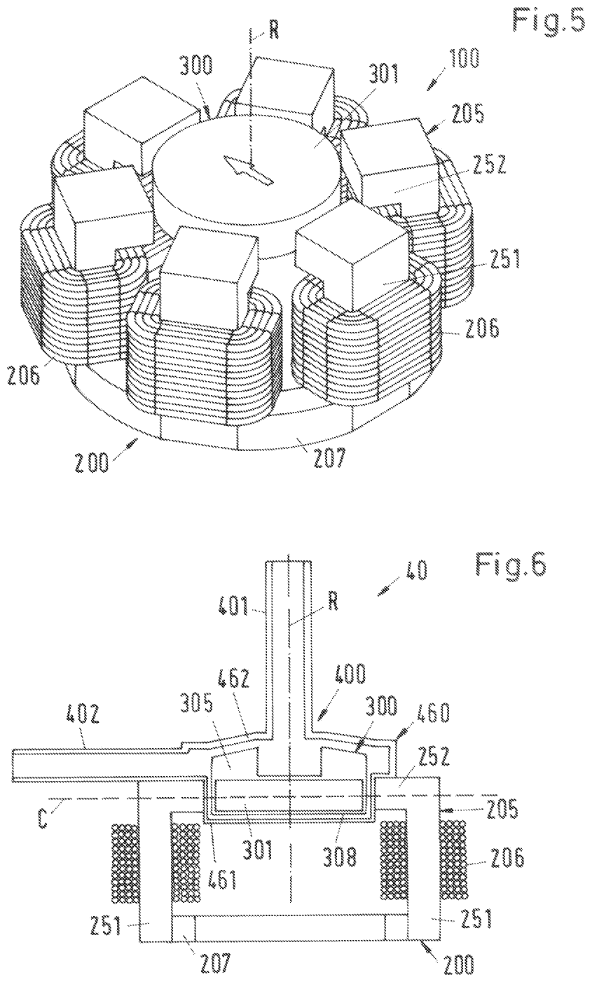

In the following, with reference to FIG. 5 and FIG. 6, a type of centrifugal pump 40 is described which is especially preferred

FIG. 5 shows in a perspective representation an electromagnetic rotary drive 100 of a centrifugal pump 40, which is designed as a temple motor. FIG. 6 shows an embodiment of a centrifugal pump 40 with a rotor 300 that can be magnetically levitated without contact, in a section in the axial direction.

The centrifugal pump 40 described in the following comprises the rotor 300 for conveying the primary fluid, and a stator 200 which forms with the rotor 300 an electromagnetic rotary drive 100 for rotating the rotor 300 about an axial direction R, wherein the rotor 300 comprises a magnetically effective core 301, and a plurality of vanes 305 (FIG. 6) for conveying the fluid, wherein the stator 200 is designed as a bearing and drive stator with which the rotor 300 can be magnetically driven without contact and can be magnetically levitated without contact with respect to the stator 200.

A particular advantage of this embodiment of the centrifugal pump 40 is that the rotor 300 is designed as an integral rotor, because it is both the rotor 300 of the electromagnetic rotary drive 100 and the rotor 300 of the centrifugal pump 40 with which the primary fluid is conveyed. In total, the rotor 300 thus fulfills three functions in one: It is the rotor 300 of the electromagnetic drive 100, it is the rotor 300 of the magnetic levitation, and it is the impeller with which the primary fluid is acted upon. This embodiment as an integral rotor offers the advantage of a very compact and space-saving design.

A further advantage is the contactless magnetic levitation of the rotor 300 with respect to the stator 200, which, due to the absence of mechanical bearings for the rotor 300, ensures that no contaminants, such as might occur in mechanical bearings, enter the primary fluid. In addition, due to the absence of mechanical bearings and the frictional forces occurring in them, the relationship between the electrical operating variables, such as drive current or drive voltage, and the rotational speed of the rotor 300 is much more precisely defined, which improves or simplifies the regulation of the centrifugal pump 40.

FIG. 5 shows a perspective representation of an embodiment of the electromagnetic rotary drive 100, which is designed as a so-called temple motor and according to the principle of the bearingless motor.

The electromagnetic rotary drive 100 is designed according to the principle of the bearingless motor and is operated according to this principle. The term bearingless motor means an electromagnetic rotary drive 100 in which the rotor 300 is levitated completely magnetically with respect to the stator 200, wherein no separate magnetic bearings are provided. For this purpose, the stator 200 is designed as a bearing and drive stator, which is both the stator 200 of the electric drive and the stator of the magnetic levitation. The stator 200 comprises electrical windings 206, with which a magnetic rotating field can be generated, which on the one hand exerts a torque on the rotor 300, which effects its rotation about a desired axis of rotation defining the axial direction R, and which, on the other hand, exerts a shear force, which can be adjusted as desired, on the rotor 300, so that its radial position can be actively controlled or regulated. Thus, three degrees of freedom of the rotor 300 can be actively regulated, namely its rotation and its radial position (two degrees of freedom). With respect to three further degrees of freedom, namely its position in the axial direction R and tilting with respect to the radial plane perpendicular to the desired axis of rotation (two degrees of freedom), the rotor 300 is preferably passively magnetically levitated or stabilized by reluctance forces, i.e., it cannot be controlled. The absence of a separate magnetic bearing with a complete magnetic levitation of the rotor 30 is the property, which gives the bearingless motor its name. In the bearing and drive stator, the bearing function cannot be separated from the drive function.

The desired axis of rotation refers to that axis about which the rotor 300 rotates in the operating state when the rotor 300 is in a centered and not tilted position with respect to the stator 200 as represented in FIG. 5 and FIG. 6. This desired axis of rotation defines the axial direction R. Usually, the desired axis of rotation defining the axial direction R corresponds to the central axis of the stator 200

In the following, a radial direction refers to a direction, which stands perpendicular on the axial direction R.

The rotor 300 comprises the magnetically effective core 301, which is designed in a ring-shaped or disk-shaped manner. According to the representation in FIG. 5, the magnetically effective core 301 is designed as a permanent magnetic disk and defines a magnetic center plane C (FIG. 6). The magnetic center plane C of the magnetically effective core 301 of the rotor 300 refers to that plane perpendicular to the axial direction R in which the magnetically effective core 301 of the rotor 300 is levitated in the operating state when the rotor 300 is not tilted and not deflected in the axial direction R. As a rule, in a disk-shaped or ring-shaped magnetically effective core 301, the magnetic center plane C is the geometric center plane of the magnetically effective core 301 of the rotor 300, which is perpendicular to the axial direction R. That plane in which the magnetically effective core 301 of the rotor 300 is levitated in the stator 200 in the operating state is also referred to as the radial plane. The radial plane defines the x-y plane of a Cartesian coordinate system whose z-axis extends in the axial direction R. If the magnetically effective core 301 of the rotor 300 is not tilted and not deflected with respect to the axial direction R, the radial plane corresponds to the magnetic center plane C.

The radial position of the magnetically effective core 301 or the rotor 300 refers to the position of the rotor 300 in the radial plane.

The “magnetically effective core 301” of the rotor 3W) refers to that region of the rotor 300 which magnetically interacts with the stator 200 for torque generation and the generation of magnetic levitation forces.

The electromagnetic rotary drive 100 is designed as a temple motor and comprises the stator 200, which has a plurality of coil cores 205—here six coil cores 205—each of which comprises a longitudinal limb 251 which extends in the axial direction R, and a transverse limb 252 arranged perpendicular to the longitudinal limb 251 which extends in a radial direction and is bounded by an end face. The coil cores 205 are arranged equidistantly on a circular line so that the end faces of the transverse limbs 252 surround the magnetically effective core of the rotor 300. A concentrated winding 206 is arranged on each longitudinal limb 251, surrounding the respective longitudinal limb 252.

The longitudinal limbs 251 of the coil cores 205, which are aligned parallel to each other, and which all extend parallel to the axial direction R, and which surround the rotor 300 are what gave the temple motor its name, because these parallel longitudinal limbs 251 are reminiscent of the columns of a temple.

In FIG. 5, only the magnetically effective core 301 of the rotor 300 is represented. Of course, it is understood that the rotor 300 can also comprise other components such as jackets or encapsulations, which are preferably made of a plastic, or of a metal, or of a metal alloy, or of a ceramic or ceramic material. Furthermore, the rotor 300 also comprises the vanes 305 for pumping the primary fluid (see FIG. 6). The rotor 300 can also comprise other components.

Those ends of the longitudinal limbs 251 which face away from the transverse limbs 252—in FIG. 5 and FIG. 6 these are the lower ends according to the representation—are connected to each other by a return 207. The return 207 is preferably designed in a ring-shaped manner or comprises several segments that connect the longitudinal limbs 251 to one another. Both the return 207 and the coil cores 205 of the stator 200 are each made of a soft magnetic material because they serve as flux conducting elements to guide the magnetic flux. Suitable soft magnetic materials for the coil cores 205 and the return 207 are, for example, ferromagnetic or ferrimagnetic materials, i.e., in particular iron, nickel-iron, cobalt-iron, silicon iron or Mu-metal. In this case, for the stator 200, a design as a stator sheet stack is preferred, in which the coil cores 205 and the return 207 are designed in sheet metal, i.e., they consist of several thin sheet metal elements, which are stacked.

In order to generate the electromagnetic rotating fields required for the magnetic drive and the magnetic levitation of the rotor 300, the longitudinal limbs 251 of the coil cores 205 carry the windings designed as concentrated windings 206, wherein exactly one concentrated winding 206 is arranged in each case around each longitudinal limb 251 in the embodiment described here. In the operating state, those electromagnetic rotating fields are generated with these concentrated windings 206 with which a torque is effected on the rotor 300 and with which a shear force, which can be adjusted as desired, can be exerted on the rotor 300 in the radial direction, so that the radial position of the rotor 300, i.e, its position in the radial plane perpendicular to the axial direction R, can be actively controlled or regulated. Of course, such embodiments are also possible in which each longitudinal limb 251 has more than one concentrated winding 206, for example, exactly two concentrated windings.

As already mentioned, the magnetically effective core 301 is designed in a permanent magnetic manner. For this purpose, the magnetically effective core 301 can comprise at least one permanent magnet, but also several permanent magnets, or—as in the embodiment described here—consist entirely of a permanent magnetic material, so that the magnetically effective core 301 is the permanent magnet. The magnetization of the magnetically effective core 301 of the rotor 300 is represented in FIG. 5 by the arrow without reference sign in the magnetically effective core 301. The magnetically effective core 301 is thus magnetized in the radial direction.

FIG. 6 shows an embodiment of the centrifugal pump 40 in a section in the axial direction R.

The centrifugal pump 40 comprises a pump unit 400 having a pump housing 460 which comprises the pump inlet 401 and the pump outlet 402 for the fluid to be conveyed, wherein the rotor 300 is arranged in the pump housing 460 and comprises a plurality of vanes 305 for conveying the fluid. The pump unit 400 is designed in such a way that the pump unit 400 can be inserted into the stator 200 such that the magnetically effective core 301 of the rotor 300 is surrounded by the end faces of the transverse limbs 252.

The pump housing 460 of the pump unit 400 comprises a base part 461 and a cover 462, which are connected to each other in a sealing manner, wherein the pump outlet 402 is preferably, but not necessarily, completely arranged in the base part 461 of the pump housing 460. The cover 462 comprises the pump inlet 401, which extends in the axial direction R, so that the primary fluid flows to the rotor 300 from the axial direction R.

The rotor 300 comprises the plurality of vanes 305 for conveying the fluid, for example a total of four vanes 305, whereby this number has an exemplary character. The rotor 300 further comprises a jacket 308 with which the magnetically effective core 301 of the rotor 300 is enclosed and preferably hermetically encapsulated so that the magnetically effective core 301 of the rotor 300 does not come into contact with the primary fluid to be conveyed. All vanes 305 are arranged on the jacket 308 and arranged equidistantly with respect to the circumferential direction of the rotor 300. Each vane 305 extends outward in the radial direction and is connected to the jacket 308 in a torque-proof manner. The vanes 305 can be separate components that are then fixed to the jacket 308. Of course, it is also possible that all of the vanes 305 are an integral part of the jacket 308, i.e., that the jacket 308 is designed with all of the vanes 305 as a single piece. The rotor 300 with the vanes 305 forms the running wheel or the impeller of the centrifugal pump 40, with which the primary fluid is acted upon

The design of the centrifugal pump 40 with the electromagnetic rotary drive 100 according to the principle of the bearingless motor also enables the rotor 300 to be capable of being separated from the stator 20 very easily. This is a significant advantage, because in this way, for example, the rotor 300 or the pump unit 400 comprising the rotor 300 can be designed as a single-use part for single use. Today, such single-use applications often replace processes in which, due to the very high purity requirements, all those components that come into contact with the substances to be treated in the process previously had to be cleaned and sterilized in an elaborate manner, for example by steam sterilization. When designed for single use, those components that come into contact with the substances or fluids to be treated are only used exactly once and are then replaced with new, i.e., unused, single-use parts for the next application.

The mixing system 1 according to the disclosure can therefore in particular also be designed in such a way that it comprises a reusable device which is designed for multiple use and a single-use device or a set of single-use parts which is/are designed for single use. The reusable device comprises in particular those components which do not come into contact with the fluid, i.e., in particular the stator 200 of the centrifugal pumps 40 and the control unit 70.

It is also possible that the mixing system 1 further comprises the reservoir 20 for the primary fluid. Such embodiments are possible in which the entire reservoir 20 is designed as a single-use part, for example as a dimensionally stable plastic container, and such embodiments in which only one component of the reservoir 20 is designed as a single-use part.

For example, the reservoir 20 then comprises a flexible insert for receiving the primary fluid, which is made of a plastic. The insert is preferably a flexible bag, for example a plastic bag or a synthetic bag, which can be folded so that it requires as little space as possible during storage. The insert can comprise additional inlets or outlets, for example for supplying additional substances, e.g., nutrient solutions or gases such as oxygen. It is also possible to provide a further inlet for receiving probes or measurement sensors with which parameters are monitored, e.g., temperature, pressure, concentrations, etc.

In this embodiment, the reservoir 20 further comprises a dimensionally stable support container, which is designed as a reusable component and for receiving the insert. The insert is designed as a single-use part for single use.

In particular with regard to such embodiments of the mixing system 1, which comprise reusable components for multiple use as well as components for single use, a set of single-use parts for a mixing system 1 according to the disclosure is further proposed, which comprises at least the following components, which are each designed as single-use parts: the eductor 10, optionally the storage container 80 for the secondary substance, the pump unit 400 for the centrifugal pump 40, the closing device 60, a plurality of tubes, which are designed for realizing the supply connection 50 and the discharge connection 90, i.e., in particular the supply tube 501, the feed tube 502 and the discharge tube 901. Optionally, the set of single-use parts can also comprise the reservoir 20 for the primary fluid, or parts of this reservoir, for example the insert designed as a plastic bag that can be inserted into the support container.

Preferably, the set of single-use parts also comprises the storage container 80 for the secondary substance. Here, such embodiments are also possible in which the storage container 80 is not a separate component but is realized by the secondary inlet 7. The storage container 80 is then an integral part of the eductor 10 or secondary inlet 7. For example, the secondary inlet 7 can be designed in such a way that it is large enough to receive the secondary substance. The storage container 80 is then an integral part of the secondary inlet 7.

The term “single-use device” or “single-use part” or “single-use component” refers to those components or parts which are designed for single-use, i.e., which can be used only once as intended and are then disposed of. For a new application, a new, previously unused single-use part must then be used. When configuring or designing the single-use device, substantial aspects are therefore that the single-use device can be manufactured as simply and economically as possible, generates few costs and can be manufactured from materials, for example plastics, that are available at the lowest possible price. It is another substantial aspect that the single-use device can be assembled as easily as possible with other components in the mixing system 1. The single-use device should therefore be able to be replaced very easily without the need for high assembly effort. Particularly preferably, the single-use device should be able to be replaced without the use of tools.

It is also an important aspect that the single-use device can be disposed of as easily as possible after use. For this reason, preference is given to materials that cause the least possible environmental impact, in particular also during disposal

It is a further substantial aspect that the components designed as a single-use device must be sterilizable for certain fields of application. In this regard, it is particularly advantageous if the single-use device or the single-use components or the single-use parts are gamma-sterilizable. In this type of sterilization, the element to be sterilized is applied with gamma radiation. The advantage of gamma sterilization, for example in comparison with steam sterilization, is in particular that sterilization can also take place through the packaging. For single-use devices in particular, it is a common practice that the parts are placed in the packaging after they are manufactured and then stored for a period of time before being shipped to the customer. Sterilization then usually takes place shortly before delivery to the customer or only by the customer. In such cases, sterilization takes place through the packaging, which is not possible with steam sterilization or other processes.

With regard to the single-use parts, it is generally not necessary for them to be sterilizable more than once. This is a great advantage, particularly in the case of gamma sterilization, because the application of gamma radiation to plastics can lead to degradation, so that multiple gamma sterilization can render the plastic unusable.

Since sterilization under high temperatures and/or under high (steam) pressure can usually be dispensed with for single-use devices, less expensive plastics can be used, for example those that cannot withstand high temperatures or that cannot be subjected to multiple high temperature and pressure levels.

Considering all these aspects, it is therefore preferred to use such plastics that can be gamma-sterilized at least once for the manufacture of the single-use parts or single-use components. The materials should be gamma-stable for a dose of at least 40 kGy to enable a single gamma sterilization. In addition, no toxic substances should be generated during gamma sterilization. In addition, it is preferred that all materials that come into contact with the substances to be mixed or the intermixed substances meet USP Class VI standards.

For manufacturing the single-use parts of the mixing system 1, the following plastics, for example, are also suitable in addition to the plastics already mentioned: polyethylene (PE), low density polyethylene (LDPE), ultra low density polyethylene (ULDPE), high density polyethylene (HDPE), ethylene vinyl acetate (EVA), polyethylene terephthalate (PET), polyvinylidene fluoride (PVDF), acrylonitrile butadiene styrene (ABS), polyacryl, polycarbonate (PC), polysulfones such as polysulfone (PSU).

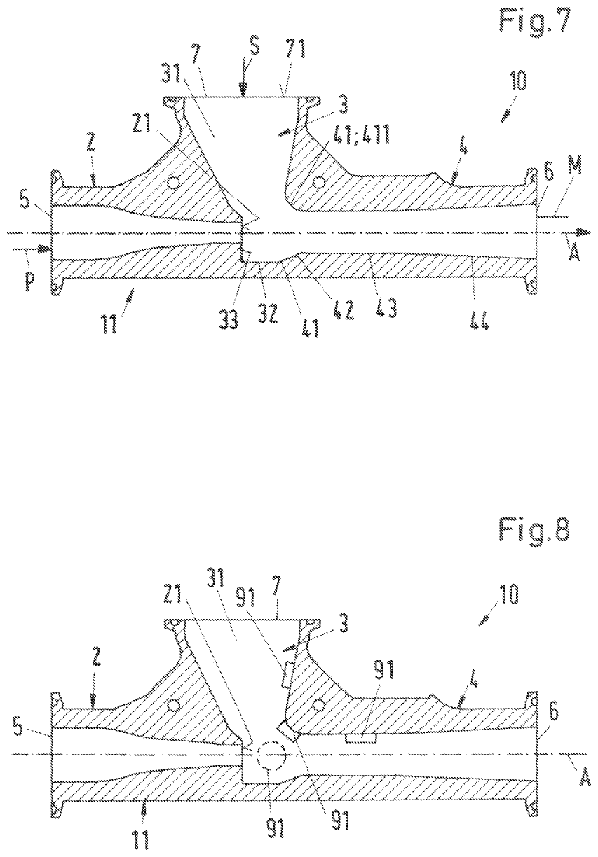

In the following, a second embodiment for the eductor 10 is explained with reference to FIG. 7, which is suitable in particular but not only for an embodiment of the eductor 10 as a single-use part. FIG. 7 shows a sectional view of this second embodiment of the eductor 10.

The eductor 10 comprises the convergingly designed inlet nozzle 2, the suction chamber 3 for sucking in the secondary substance, and the outlet nozzle 4, which is preferably designed as a venturi nozzle.

The inlet nozzle 2 has a longitudinal axis defining the center axis A of the eductor 10. The outlet nozzle 4 has a longitudinal axis lying on the center axis A of the eductor 1, i.e., the inlet nozzle 2 and the outlet nozzle 4 are designed such that their longitudinal axes are aligned with each other.

Viewed in the direction of the center axis A, the suction chamber 3 is arranged between the inlet nozzle 2 and the outlet nozzle 4. The suction chamber 3 has the secondary inlet 7 for the secondary substance. The secondary inlet 7 forms the inlet surface 71 through which the secondary substance enters the eductor 10, as the arrow with the reference sign S in FIG. 7 indicates. The secondary inlet 7 is designed in such a way that the normal vector of the inlet surface 71 is perpendicular to the center axis A of the eductor 10. Opposite the secondary inlet 7, a bottom 32 is provided which delimits the suction chamber 3. Furthermore, a side wall 33 is provided which delimits the suction chamber 3, wherein the side wall 33 is arranged at right angles or at least approximately at right angles to the bottom 32. Between the side wall 33 and the secondary inlet 7, the suction chamber 3 has a hopper-shaped designed inlet area 31, which tapers as viewed from the secondary inlet 7 in the direction of the bottom 32.

The inlet nozzle 2 extends from a primary inlet 5 for the primary fluid to the side wall 33 of the suction chamber 3. In the operating state, the primary fluid flows through the primary inlet 5 in the direction of the center axis A as the arrow with the reference sign P in FIG. 7 indicates. The inlet nozzle 2 has an outlet surface 21 through which the primary fluid enters the suction chamber 3. The outlet surface 21 has a normal vector which lies on the center axis A. The outlet surface 21 of the inlet nozzle 2 is arranged in the side wall 33 of the suction chamber 3, so that the inlet nozzle 2 does not project beyond the side wall 33 but ends flush with the side wall 33. In particular, the inlet nozzle 2 does therefore not project into the suction chamber 3. Due to this embodiment, dead zones in the suction chamber 3 between the inlet nozzle 2 and the bottom 32 are avoided.

The outlet nozzle 4 extends from the suction chamber 3 to the outlet 6. In the operating state, the mixed fluid, i.e., the primary fluid intermixed with the secondary substance, exits the eductor 10 through the outlet 6 as the arrow with the reference sign M in FIG. 7 indicates.

The outlet nozzle 4 has an entering edge 41 which is arranged directly at the bottom 32 of the suction chamber 3. The entering edge 41 is arranged at the suction chamber 3 opposite the side wall 33 and extends along the entire lateral extent of the suction chamber 3 around the center axis A. In the region of the inlet area 31 of the suction chamber 3, the entering edge 41 is designed to be strongly rounded as a rounding 411 in order to avoid a sharp edge and to enable the smoothest possible transition from the inlet area 31 of the suction chamber 3 into the outlet nozzle 4.

The outlet nozzle 4 is preferably designed as a venturi nozzle. Downstream of the entering edge 41 of the outlet nozzle 4, the converging section 42 therefore follows in which the cross-sectional area of the outlet nozzle 4 available for the flow is reduced to a minimum value. Downstream of the converging section 42, the mixing section 43 can be provided in which the cross-sectional area remains substantially constant. In the mixing section 43, the inner diameter of the outlet nozzle 4 is substantially constant. The nixing section 43 serves to mix the primary fluid with the secondary substance. The diverging section 44, which serves as a diffuser and extends to the outlet 6 of the outlet nozzle 4, adjoins the mixing section 43 downstream. The cross-sectional area available for the flow increases in the diverging section 44, as viewed in the flow direction.

The rounding 411 of the entering edge 41 of the outlet nozzle 4 provided at the inlet area 31 can extend to the beginning of the mixing section 43, as viewed in the flow direction. The converging section 42 is designed substantially in the shape of a truncated cone in the area of the bottom 32 of the suction chamber 3.

The entering edge 41 of the outlet nozzle 4 has, where it adjoins the bottom 32 of the suction chamber 3, a distance from the center axis A of the eductor 10 which is at least the same size as the distance of the bottom 32 of the suction chamber 3 from the center axis A of the eductor 10. In the embodiment described here, the distance of the entering edge 41 from the center axis A of the eductor 10 is the same size as the distance of the bottom 32 of the suction chamber 3 from the center axis A.

With respect to the normal operating position which is represented in FIG. 7, the bottom 32 of the suction chamber 3 is thus at the same level as the entering edge 41 of the outlet nozzle 4 adjacent to it. Thus, there is no boundary surface of the suction chamber 3 that lies below (with respect to the representation in FIG. 7) the entering edge 41 of the outlet nozzle 4. Due to this embodiment, the formation of dead zones between the suction chamber 3 and the outlet nozzle can be avoided or at least considerably reduced.

As can be seen in FIG. 7, all boundary surfaces of the suction chamber 3, i.e., in particular also the bottom 32 and the side wall 33 of the suction chamber 3, are fully visible from the secondary inlet 7 in the embodiment described here. Thus, there are no undercuts or covered areas in which dead zones could form. Dead zones or stagnation zones for the flow are areas, in which there is at most very little flow, or where there is only very weak mixing of the primary fluid with the secondary substance.

In the embodiment described here, the inlet nozzle 2, the suction chamber 3 and the outlet nozzle 4 are designed as a one-piece unit 11. In particular, it is also possible that the entire eductor 10 is designed as one piece.

The one-piece unit 11 has a monolithic design, i.e., it is not composed of multiple components, but it is a single piece. Consequently, the one-piece unit 11 is free of bondings, screw connections, welding seams, seals, and contacts between adjacent components.

The inlet nozzle 2, the suction chamber 3 and the outlet nozzle 4 are designed as cavities in the one-piece unit 11. The primary inlet 5, the secondary inlet 7 and the outlet 6 are each designed as an opening in the one-piece unit 11.

Particularly preferably, the one-piece unit 11 is designed as a one-piece injection molded part. Thus, the one-piece unit 11 is preferably manufactured by an injection molding process.

Of course, other methods for manufacturing the one-piece unit 11 are also suitable, for example, methods of additive manufacturing such as the method designated as 3D printing.

Since the suction chamber 3 in particular is designed without undercuts and neither the inlet nozzle 2 nor the outlet nozzle 4 project into the suction chamber, the one-piece unit 11 can be designed to be demoldable. Thus, the one-piece unit 11 can be easily manufactured in an injection molding process. Only one injection molding process is required to produce the one-piece unit.

In particular, but not only with regard to applications in the biotechnological and pharmaceutical industries, the eductor 10 preferably has a hygienic design. Hygienic design refers to a design in which dead zones are avoided as far as possible. In addition, material deposits on the inner walls or on the inner surfaces of the one-piece unit 11 delimiting the suction chamber 3, the inlet nozzle 2 and the outlet nozzle 4 are to be avoided or at least minimized as far as possible.

With regard to this hygienic design, the following measures are preferred for the design of the eductor 10:

The suction chamber 3 does not have a boundary surface that lies below (with respect to the representation in FIG. 7) the lower entering edge 41 of the outlet nozzle 4 according to the representation.

All surfaces which delimit the suction chamber 3 are visible as viewed from the secondary inlet 7.

All inner surfaces of the one-piece unit 11 which delimit the inlet nozzle 2, the suction chamber 3 and the outlet nozzle 4 are designed with an average roughness value of at most 0.8 micrometers, preferably at most 0.4 micrometers and more particularly at most 0.2 micrometers.

Sharp edges are avoided as far as possible inside the one-piece unit 11.

With regard to the integration of the eductor 10 into the mixing system 1, it can be advantageous if the eductor 1 has one or more sensors for process monitoring. In particular, the eductor 10 can comprise the sensor 91 for determining the suction power of the eductor 10. The sensor 91 is preferably designed as a pressure sensor to determine the suction power of the eductor 10.

Referring to FIG. 8 to FIG. 10, some possibilities for providing at least one pressure sensor 91 or another sensor 91 at or in the eductor 10 are explained in a non-exhaustive list. Apart from the sensors 91, the representations in FIG. 8 to FIG. 10 correspond in each case to the representation in FIG. 7.

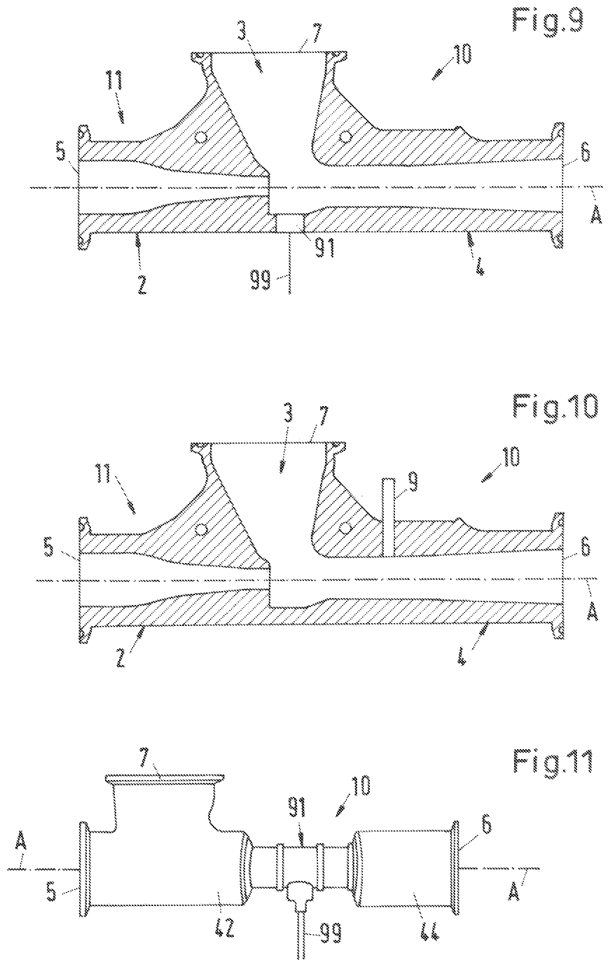

FIG. 8 shows four placements for the pressure sensor 91, where the at least one pressure sensor 91 can be placed to determine the suction power of the eductor 10 in the operating state. It is understood that more than one pressure sensor 91 can be provided, or that other sensors 91 can be provided in addition to a pressure sensor. It is usually sufficient if at least one pressure sensor 91 is provided. The representation of the pressure sensors 91 is to be understood as schematic, because the pressure sensor(s) 91 is/are preferably designed and arranged such that it/they do not projects/project, or at least do not projects/project substantially, into the interior of the one-piece unit 11. For example, the pressure sensors 91 can be injected at the respective location during the injection molding process by which the one-piece unit 11 is manufactured (see, for example, FIG. 9), so that they do not project into the interior of the one-piece unit 11, but are arranged flush with the respective inner surface, for example.

As indicated in FIG. 8, the pressure sensor 91 can be arranged in or at the side wall 33 in which the inlet nozzle 2 terminates. The pressure sensor 91 is then preferably arranged with respect to the circumferential direction of the suction chamber 3 at a distance from the outlet surface 21 of the inlet nozzle 2, for example at the same height but offset by about 90° with respect to the circumferential direction from the outlet surface 21.

Furthermore, it is possible that the pressure sensor 91 is arranged in or at the suction chamber 3 and adjacent to the secondary inlet 7, more specifically in or at the inlet area 31 of the suction chamber 3.

The pressure sensor 91 can further be arranged in or at the entering edge 41 of the outlet nozzle 4, preferably in or at the rounding 411.

It is a further preferred placement that the pressure sensor 91 is arranged in or at the outlet nozzle 4, preferably in the mixing section 43, or in the area in which the outlet nozzle 4 has its smallest cross-sectional area, respectively.

FIG. 9 shows a variant in which the pressure sensor 91 is injected into the bottom 32 of the suction chamber 3. For example, the pressure sensor 91 can be a commercially available single-use pressure sensor 91 which is injected during the manufacture of the one-piece unit 11. The measurement values of the pressure sensor 91 can be transmitted to the control unit 70 (not represented in FIG. 9) via the signal connection 99.

FIG. 10 shows a variant in which the eductor 10 has a connector 9 which is designed for receiving a pressure sensor 91 (not represented in FIG. 10). Here, the connector 9 is designed in such a way that it is applied with the pressure prevailing in the eductor 1. Preferably, the connector 9 is provided at the outlet nozzle 4, for example in the mixing section 43 of the outlet nozzle 4. The connector 9 is designed in such a way that it can receive or be connected to an external pressure sensor. For example, the external pressure sensor 91 can be a commercially available pressure sensor 91 with a luer lock connector, whereby the connector 9 is connected to the external pressure sensor 91 via the luer lock.

Further variants for the connection of the pressure sensor 91 to the eductor 10 are, for example, the design as a tri-clamp or barb connector.

Of course, the external sensor can also be designed as a single-use sensor.

Furthermore, it is possible that the eductor 10 has an integrated membrane which is arranged and designed in such a way that it is applied with the pressure prevailing in the eductor 10. Then, this integrated membrane interacts with an external pressure sensor to determine the pressure. For this purpose, commercially available single-use in-line membranes for connection to pressure sensors are suitable, for example.

Furthermore, it is possible to provide an inline sensor 91 in or behind the outlet nozzle 4, with which the pressure can be determined. In this respect, FIG. 11 shows a view of a third embodiment of an eductor 10 with an inline sensor 91.

The inline sensor 91 can be designed with a tri-clamp connector, for example. The pressure sensor 91 can then be arranged between the converging section 42 of the outlet nozzle 4 and the diverging section 44 of the outlet nozzle 4 of the eductor 10, so that the mixed fluid flows through the pressure sensor 91.

The sensor 91 can be a sensor 91 other than a pressure sensor 91. Further variants are possible for sensors 91, which can be provided in or at the eductor 10. For the determination of the suction power of the eductor 10 with which the secondary substance is sucked in through the secondary inlet 7, and/or for the detection of an overflow of the eductor 10 or for the detection of a leakage flow which exits the eductor 10 through the secondary inlet 7, a flow sensor or a level sensor or a sensor for conductivity measurement can be provided, for example. These sensors are preferably arranged adjacent to the secondary inlet 7, for example in or at the inlet area 31 of the suction chamber 3. For example, an ultrasonic sensor or a mass flow sensor is suitable as a flow sensor.

What is claimed is:

1. A mixing system, comprising:
an eductor configured to mix a primary fluid with a flowable secondary substance,
a reservoir for the primary fluid,
a supply connection configured to be connected to the reservoir;
a discharge connection to discharge a mixed fluid;
a storage container for the secondary substance;
a centrifugal pump configured to convey the primary fluid through the supply connection;
a controller configured to control the centrifugal pump,
the eductor comprising a primary inlet for the primary fluid, a secondary inlet for the secondary substance, an outlet for the mixed fluid, and a suction chamber to suck the secondary substance, the primary inlet connected to the supply connection so that the primary fluid is capable of flowing from the reservoir into the eductor, the outlet connected to the discharge connection so that the mixed fluid is capable of being discharged from the eductor, the secondary inlet disposed at the suction chamber and connected to the storage container, a closing device with an open position and a closed position is disposed between the suction chamber and the storage container, the secondary substance capable of flowing from the storage container into the suction chamber when the closing device is in the open position, and the closing device is configured to prevent a flow of the secondary substance from the storage container into the suction chamber in the closed position; and
a sensor configured to determine a suction power of the eductor, the sensor signal-connected to the controller, and the controller configured to control the centrifugal pump in dependence on the determined suction power.

2. The mixing system according to claim 1, wherein the supply connection is connected to the reservoir for the primary fluid, and the discharge connection is connected to the reservoir so that the mixed fluid is capable of being returned from the outlet of the eductor into the reservoir.

3. The mixing system according to claim 1, further comprising a first shut-off valve in the discharge connection.

4. The mixing system according to claim 3, further comprising a second shut-off valve in the supply connection between the centrifugal pump and the primary inlet of the eductor.

5. The mixing system according to claim 4, wherein each of the first and second shut-off valves is a controllable shut-off valve capable of being controlled by the controller.

6. The mixing system according to claim 1, wherein the closing device is capable of being controlled by the controller, and of the controller is configured to automatically activate the closing device.

7. The mixing system according to claim 5, wherein the controller is configured to close the supply connection or close the discharge connection, or to set the closing device into the closed position when the suction power falls below a threshold value.

8. The mixing system according to claim 1, wherein the sensor is a pressure sensor.

9. The mixing system according to claim 1, wherein an additional reservoir for receiving a fluid flowing back from the discharge connection is disposed between the secondary inlet of the eductor and the closing device.

10. The mixing system according to claim 1, wherein the centrifugal pump comprises a pump unit having a pump housing in which a rotor is provided to convey the primary fluid, and a stator forming an electromagnetic rotary drive with the rotor (300), the rotor is capable of being magnetically driven without contact and magnetically levitated without contact with respect to the stator, and the pump unit is configured to be inserted into the stator.

11. A set of single-use parts for a mixing system according to claim 10, comprising:
the eductor,
the pump unit for the centrifugal pump;
the closing device; and
a plurality of tubes configured to realize the supply connection and the discharge connection.

12. A method for mixing a primary fluid with a flowable secondary substance, comprising:
providing a mixing system according to claim 1
setting the closing device into the closed position;
conveying the primary fluid through the eductor by the centrifugal pump;
determining the suction power of the eductor by the sensor and the controller; and
setting the closing device in the open position when the suction power is greater than a predeterminable limit value.

13. The method according to claim 12, wherein the supply connection or the discharge connection are closed when the suction power drops below a threshold value.

14. The method according to claim 12, wherein the closing device is set in the closed position when the suction power drops below a threshold value.

15. The method according to claim 12, wherein pressure in the suction chamber is determined in order to determine the suction power.

16. A set of single-use parts for a mixing system according to claim 10, comprising:
the eductor;
the storage container for the secondary substance;
the pump unit for the centrifugal pump;
the closing device; and
a plurality of tubes configured to realize the supply connection and the discharge connection.

17. A set of single-use parts for a mixing system according to claim 10, comprising:
the eductor;
the pump unit for the centrifugal pump;
the closing device;
a plurality of tubes configured to realize the supply connection and the discharge connection; and
the reservoir for the primary fluid.
